(19) United States
(12) Patent Application Publication
(10) Pub. No.: US 2024/0381248 A1
(43) Pub. Date: Nov. 14, 2024

(54) RADIO FUNCTION AWARE DYNAMIC TRANSMISSION PROCEDURES FOR NETWORK ENERGY SAVING

(71) Applicant: Dell Products, L.P., Round Rock, TX (US)

(72) Inventor: Ali Esswie, Calgary (CA)

(21) Appl. No.: 18/314,033

(22) Filed: May 8, 2023

(51) Int. Cl. H04W 52/02; H04W 76/28

(52) U.S. Cl. CPC H04W 52/0216; H04W 52/0245; H04W 76/28

(57) ABSTRACT

A radio access network node may configure one or more user equipment via a partial transmission mode function indication that may indicate one or more radio transmission functions that the node may activate, or make continuous active, during a discontinuous transmission OFF period. The node may determine some functions to continue as active with respect to one user equipment, or group of user equipment, during a discontinuous transmission OFF period based on traffic characteristics, or other characteristics, corresponding to a user equipment. The node may determine different functions to continue as active with respect to another user equipment, or group of user equipment, during the same discontinuous transmission OFF period based on different traffic characteristics, or other characteristics, corresponding to other user equipment. The node may transmit different partial transmission mode function indications to different user equipment based on different codes.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise transmitting, by a radio access network node comprising a processor to a user equipment, a transmission mode configuration comprising at least one partial transmission off mode function indication indicative of at least one transmission function that is to be active during at least one partial transmission off mode period and operating, by the radio access network node, at least one of the at least one transmission function during at least one of the at least one partial transmission off mode period.

The at least one transmission function may comprise at least one of: a sounding reference signal function, a reference signal function, a downlink control information format function, a demodulation reference signal function, or a traffic function. Performing the at least one transmission function may comprise transmission of TRAFFIC, transmitting CSI-RS pattern identifiers, transmitting STS information, such as reports, transmitting DCI format identifiers, transmitting DMRS patterns identifiers, transmitting PTRS pattern identifiers, or transmitting QCI identifiers.

In an embodiment, the at least one of the at least one partial transmission off mode period may coincide with a configured discontinuous transmission off period. In another embodiment, the at least one of the at least one partial transmission off mode period may be at least partially noncoincidental with a configured discontinuous transmission off period. A partial transmission off mode period may be referred to as a partial transmission OFF mode period. A partial transmission off mode period may be a partial DTX OFF period.

In an embodiment, the example method may further comprise analyzing, by the radio access network node, a power supply parameter value with respect to a power supply parameter criterion, for example whether loss of offsite power to the radio access network node has occurred, or whether a battery charge level has dropped below a battery charge threshold, to result in an analyzed power supply parameter. The determining to operate the at least one of the at least one transmission function during the at least one of the at least one partial transmission off mode period may be based on the analyzed power supply parameter value being determined to satisfy the power supply parameter criterion.

The transmission mode configuration may comprise an off mode period indication indicative of a period parameter corresponding to the at least one partial transmission off mode period. The period parameter may be an off mode period indication may be a duration. The period parameter may be an off mode period indication may be a periodicity.

The at least one partial transmission off mode function indication may be a first partial transmission off mode function indication and the at least one transmission function that is to be active during the at least one partial transmission off mode period may be a first transmission function. The at least one partial transmission off mode period may be a first partial transmission off mode period, and the transmission mode configuration may comprise a second partial transmission off mode function indication indicative of a second transmission function that is to be active during a second off mode period. The transmission mode configuration may comprise a first off mode period indication indicative of a first period parameter value corresponding to the first partial transmission off mode period, and the transmission mode configuration may comprise a second off mode period indication indicative of a second period parameter value corresponding to the second partial transmission off mode period. The first period parameter value may be a first duration corresponding to the first partial transmission off mode period and the second period parameter value may be a second duration corresponding to the second partial transmission off mode period.

In an embodiment, the at least one partial transmission off mode function indication may comprise a partial transmission off mode index corresponding to the at least one of the at least one partial transmission off mode period. The example method may further comprise transmitting, by the radio access network node to the user equipment, the partial transmission off mode index to be indicative, to the user equipment, of the operating of the at least one of the at least one transmission function during the at least one of the at least one partial transmission off mode period.

In an embodiment, the user equipment may be a first user equipment, the at least one partial transmission off mode function indication may be a first partial transmission off mode function indication. The transmission mode configuration may further comprise a second partial transmission off mode function indication indicative of the at least one of the at least one transmission function being inactive during the at least one partial transmission off mode period. The method may further comprise transmitting, by the radio access network node to a second user equipment, the transmission mode configuration. The method may further comprise transmitting, by the radio access network node to the first user equipment, the first partial transmission off mode indication to be indicative to the first user equipment that the at least one of the at least one transmission function is to be active during the at least one of the at least one partial transmission off mode period. The method may further comprise transmitting, by the radio access network node to the second user equipment, the second partial transmission off mode indication to be indicative to the second user equipment that the at least one of the at least one transmission function is to be inactive during the at least one of the at least one partial transmission off mode period. The operating of the at least one of the at least one transmission function during the at least one of the at least one partial transmission off mode period may comprise operating the at least one of the at least one transmission function with respect to the first user equipment and excluding operating of the at least one of the at least one transmission function with respect to the second user equipment.

In an embodiment, the first partial transmission off mode function indication may comprise a first partial transmission mode index, and the second partial transmission off mode function indication may comprise a second partial transmission mode index.

In another example embodiment, a radio access network node may comprise a processor configured to transmit, to a first user equipment and a second user equipment, a transmission mode configuration comprising a first partial transmission off mode function indication that indicates that at least one transmission function that is to be active during at least one partial transmission off mode period and a second partial transmission off mode function indication that indicates that the at least one transmission function is to be inactive during the at least one partial transmission off mode period. The processor may be further configured to transmit, to the first user equipment, the first partial transmission off mode function indication and to transmit, to the second user equipment, the second partial transmission off mode function indication. The processor may be further configured to operate, by the radio access network node with respect to the first user equipment, the at least one transmission function during the at least one partial transmission off mode period and to exclude, by the radio access network node with respect to the second user equipment, operation of the at least one transmission function during the at least one partial transmission off mode period.

In an embodiment, the radio access network node may transmit the first partial transmission off mode function indication to the first user equipment according to a first device-specific scrambling code uniquely corresponding to the first user equipment. The radio access network node may transmit the second partial transmission off mode function indication to the second user equipment according to a second device-specific scrambling code uniquely corresponding to the second user equipment.

In an embodiment, the first user equipment may be a member of a first group of at least one user equipment, and the second user equipment may be a member of a second group of at least one user equipment. The radio access network node may transmit the first partial transmission off mode function indication to the first group of at least one user equipment according to a first group-specific scrambling code uniquely corresponding to the first group of at least one user equipment. The radio access network node may transmit the second partial transmission off mode function indication to the second group of at least one user equipment according to a second group-specific scrambling code uniquely corresponding to the second group of at least one user equipment.

In yet another embodiment, a non-transitory machine-readable medium, may comprise executable instructions that, when executed by a processor of a radio access network node, facilitate performance of operations, comprising transmitting, to a first user equipment and a second user equipment, a transmission mode configuration comprising a first partial transmission off mode function indication indicative of a first transmission function that is to be active during at least one partial transmission off mode period. The transmission mode configuration may comprise a second partial transmission off mode function indication indicative of a second transmission function that is to be active during the at least one partial transmission off mode period. The first user equipment may be a member of a first group of at least one user equipment and the second user equipment is a member of a second group of at least one user equipment. The operations may comprise transmitting the first partial transmission off mode function indication to the first group of at least one user equipment according to a first group-specific scrambling code corresponding to the first group of at least one user equipment. The operations may comprise transmitting the second partial transmission off mode function indication to the second group of at least one user equipment according to a second group-specific scrambling code corresponding to the second group of at least one user equipment. The operations may comprise operating, with respect to the first user equipment, the first transmission function during the at least one partial transmission off mode period, excluding from operating, with respect to the first user equipment, the second transmission function during the at least one partial transmission off mode period, and operating, with respect to the second user equipment, the first transmission function and the second transmission function during the at least one partial transmission off mode period.

In an embodiment the operations may further comprise analyzing a first signal strength corresponding to at least one of the first group of at least one user equipment with respect to a first signal strength criterion to result in an analyzed first signal strength. Based on the analyzed first signal strength being determined to satisfy the first signal strength criterion, the operations may further comprise determining to transmit the first partial transmission off mode function indication to the first group of at least one user equipment.

In an embodiment, the operations may further comprise analyzing a second signal strength corresponding to at least one of the second group of at least one user equipment with respect to a second signal strength criterion to result in an analyzed second signal strength. Based on the analyzed second signal strength being determined to satisfy the second signal strength criterion, the operations may further comprise determining to transmit the second partial transmission off mode function indication to the second group of at least one user equipment. The satisfaction of the first signal strength criterion may correspond to a determination of a first signal strength value that is higher than a second signal strength value that satisfies the second signal strength criterion. For example, user equipment of the first group may have a better signal strength/coverage with respect to the radio access network node than user equipment of the second group and thus can operate satisfactorily with less radio functionality (e.g., less reference signaling) during the partial off period, whereas the second group may be farther away from the RAN and thus may have weaker signal strength/coverage and thus may need more functionality (e.g., more reference signaling) to remain operational during the partial OFF period.

### BRIEF DESCRIPTION OF THE DRAWINGS

FIG. 1 illustrates wireless communication system environment.

FIG. 2 illustrates an example environment with multiple user equipment in multiple groups of user equipment.

FIG. 3 illustrates an example environment with a radio access network node operating different radio functions with respect to different user equipment during a configured discontinuous transmission OFF period.

FIG. 4A illustrates a diagram of all radio functions being shut down at a radio access network node during a configured discontinuous OFF period.

FIG. 4B illustrates a diagram of some radio functions being shut down and other radio functions being active at a radio access network node during a configured partial discontinuous transmission OFF period.

FIG. 5 illustrates an example transmission mode configuration.

FIG. 6 illustrates an example partial transmission off mode function indication.

FIG. 7 illustrates a timing diagram of an example embodiment of operating at least one radio function during a configured discontinuous transmission OFF period.

FIG. 8 illustrates a flow diagram of an example embodiment method using at least one radio function being operated during a configured discontinuous transmission OFF period.

FIG. 9 illustrates a block diagram of an example method embodiment.

FIG. 10 illustrates a block diagram of an example radio access network node.

FIG. 11 illustrates a block diagram of an example non-transitory machine-readable medium embodiment.

FIG. 12 illustrates an example computer environment.

FIG. 13 illustrates a block diagram of an example wireless user equipment.

FIG. 14 illustrates a resource diagram showing some reference signals resources being active during a partial discontinuous transmission OFF period.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘anything reality’ (“XR”) services. XR services may comprise VR applications, which are widely adopted XR applications that provide an immersive environment which can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate, but may also be sporadic, or bursty, in nature. In addition, different packet traffic flows of a single XR communication session may affect an end user's experience differently. For instance, a smart glass that is streaming 180-degree high-resolution frames may use a large percentage of a broadband service's capacity for fulfilling user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at XR capable device is desirable. Accordingly, a user equipment device accessing XR services, or traffic flows of an XR session, may be associated with certain QoS metrics to satisfy performance targets of the XR service in terms of perceived data rate or end to end latency and reliability, for example.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic while minimizing power consumption.

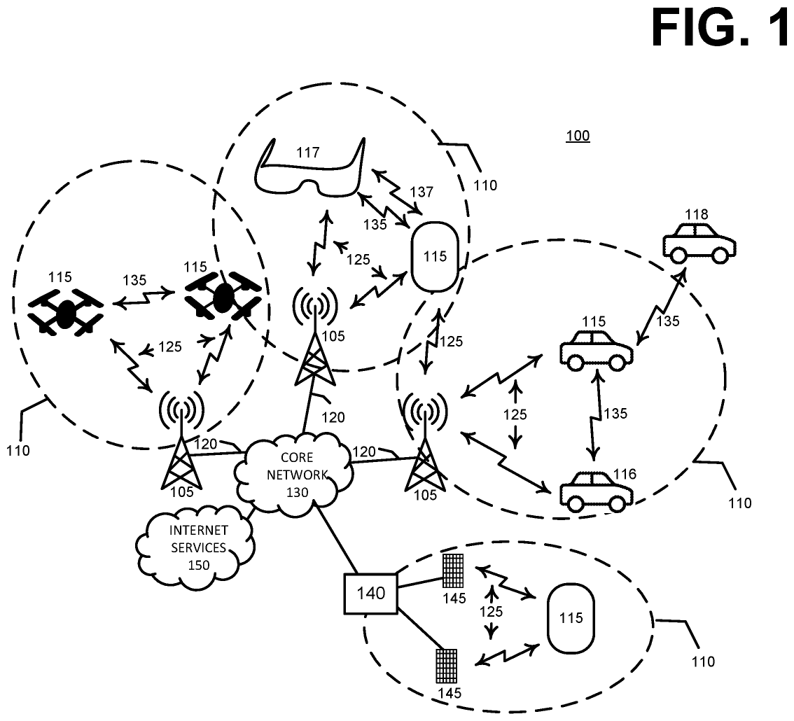

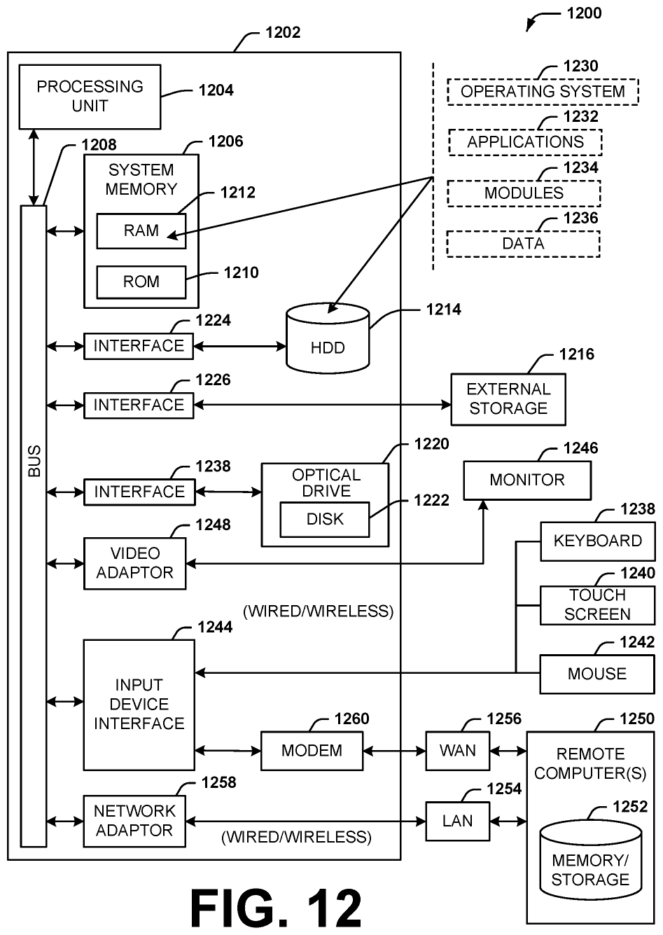

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 12.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (eg., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The performance of a communication network in providing an XR service may be at least partially determined according to satisfaction of a user of the XR services. Each XR-service-using user device may be associated with certain QoS metrics to satisfy the performance targets of the user's service, in terms of perceived data rate, end-to-end latency, and reliability.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

### Discontinuous Transmission (“DTX”) and Discontinuous Reception (“DRX”)

DTX and DRX procedures may facilitate efficient energy saving gain at the RAN nodes and user equipment devices. DTX may refer to a transmitter, which may be a UE transmitter or a RAN node transmitter, transmitting radio signals including traffic, reference signals, or control information during certain periods of time, (e.g., periodic DTX ON periods) while the UE or RAN transmitter otherwise remains in DTX OFF. During a DTX OFF state, or DTX OFF period, most of, or all of, a transmitter's transmission radio chain may be shut down to achieve an energy saving gain. DRX may refer to a receiver being able to receive radio signals (traffic, control information and/or reference signals) during periodic DRX ON periods while otherwise being an OFF state during which radio circuits or functions may be off or idle. During a DRX OFF period a user equipment device may be considered as not effectively connected to a RAN network since the UE shuts down partially or fully its reception radio chain during a DRX OFF period.

DTX and DRX procedures may facilitate energy saving gains due to regular deactivation of either or both of receiver and transmitter chains. However, shutting down a transmitter or receiver chain may come at the expense of degraded radio performance, since during DTX OFF or DRX OFF periods transmitters or receivers are not available for radio operations. Thus, DRX OFF periods or DTX OFF periods may cause, or increase, traffic buffering delay. For example, when a packet is available at a RAN node for transmission towards a user equipment device, but the user equipment device is currently operating according to a configured DRX OFF period such that the user equipment's radio frequency receiver chain is not operational the user equipment cannot receive radio traffic payload. Accordingly, the RAN node transmitter may buffer such available traffic until the user equipment's DRX ON period begins when the UE becomes able to receive radio signals. A straightforward solution to minimize buffering delay due to primary DRX OFF period buffering is to set the periodicity of the user equipment's DRX ON period to be aligned in time with a periodicity, which may be a statistical average periodicity, corresponding to traffic packet arrivals that are directed to the user equipment. However, for multi-flow traffic, where different traffic flows have different respective packet arrival periodicities, existing single periodicity and static DRX cycle deigns may not efficiently support latency-critical traffic delivery.

Although energy saving is desirable and energy saving gains can be obtained at user equipment devices or at radio access network nodes, energy saving techniques may negatively impact basic radio signaling and functionality. 5G NR systems currently may implement various techniques for achieving energy saving. For example, to achieve an energy saving gain at a radio access network node, discontinuous transmission (“DTX”) techniques may facilitate balancing and optimizing power use and radio function performance. According to conventional techniques, during a DTX cycle a radio access network node may transmit various radio signals or perform various transmission radio functions only during certain periodically occurring time periods, (e.g., during configured DTX ON periods). During the remaining time, (e.g., during DTX OFF periods), the RAN node/network shuts down its radio transmitter or transceiver. Thus, no radio transmissions from the network node are expected by a user equipment during a DTX OFF period. Operating according to conventional DTX techniques may result in network energy saving. However, operating according to conventional DTX techniques may come at the expense of degraded radio performance. For example, existing DTX procedures entail a static DTX design, according to which all radio transmissions, for all devices and traffic types, are halted during DTX OFF periods, with radio transmissions, or radio transmission functionality, resuming during DTX ON periods. Such static design does not suit coexistence deployments, (e.g., multiple device classes that may have respectively different traffic characteristics and quality of service (“QoS”) targets/requirements). Radio functionality that a network node provides during a DTX ON period may be referred to as default functionality.

A fixed DTX design may significantly degrade radio performance with respect to traffic flows having a stringent QoS requirement and may limit a RAN node's flexibility in trading off achievable energy saving gain in favor of radio performance targets. For example, when latency critical fast-arriving traffic packet arrival at a RAN node, and are available at the RAN node for transmission to a user equipment, the RAN node may not be able to adopt sufficiently long DTX OFF periods without causing violation of one or more latency targets of the packets. Thus, using a conventional static DTX configuration design may result in little energy saving if performance requirements for one or more traffic flows are to be satisfied.

Embodiments disclosed herein may facilitate dynamic DTX configurations that may enable RAN nodes to flexibly implement radio-function-active DTX OFF periods that may result in significant energy saving without violating traffic stringent radio QoS performance requirements of one or more traffic flows. Unlike with existing DTX design techniques, adaptive DTX embodiments disclosed herein may facilitate a radio access network node dynamically shutting down radio functionality with respect to all of, or a subset of, active user equipment devices being serviced by the radio access network node, based on the tolerance of a user equipment, or of an application executing thereon, to radio functionality being shut down during a DTX OFF period.

According to embodiments disclosed herein, all radio functionality may not necessarily be shut down during a DTX OFF period. Instead, according to embodiments disclosed herein, a RAN node may shut down some, but not all radio functions, or the node may ‘relax’ certain radio functions, with respect to certain user equipment, or with respect to certain groups of user equipment. For example, for traffic transmitted to a user equipment that is latency-critical (e.g., conducting a communication session with a RAN node that comprises one or more traffic flows having a stringent latency target or requirement), the RAN node may temporarily relax (e.g., stop or adopt a less energy consuming pattern) transmission of downlink reference signals and/or demodulation reference signals on condition that the user equipment device to which the stringent traffic is directed can remain able to decode packets of the traffic (e.g., the device has a high signal to interference to ratio and thus can decode packets even without having performed beam management procedures with respect to reference signals received from the RAN). According to embodiments disclosed herein, a user equipment device may be configured with a list of available DTX function groups, where each function group defines certain transmission behavior of the RAN node with respect to the user. Thus, user equipment with an active communication session comprising a critical traffic flow (e.g., the flow has a stringent QoS requirement) can be dynamically configured to operate with a RAN that provides radio functionality of the function group during a DTX OFF period to facilitate fast and reliable traffic packet transmission, while another user equipment with an active communication session comprising one or more best effort traffic flows can be configured to operate with the RAN that transmits the best effort traffic according to a less energy-consuming function group during the DTX OFF period. Thus, The RAN node can still achieve energy saving gain from performing occasional dynamic DTX OFF while still being able to support stringent QoS requirements of critical devices and/or traffic flows. Embodiments disclosed herein facilitate a change of user equipment and radio access network node behavior with respect to conventional techniques (e.g., being able to receive/transmit multiple radio signals according to transmission configurations during DTX OFF periods), which novel behavior may comprise not fully shutting down/shutting off transmission functionality during a DTX OFF period. Instead, according to embodiments disclosed herein, different sets of transmission configurations may be implemented depending on criticality of devices and/or traffic flows of interest, and new supported signaling exchange messages may be implemented.

### Radio-Function-Dependent Discontinuous Transmission for Network Energy Saving

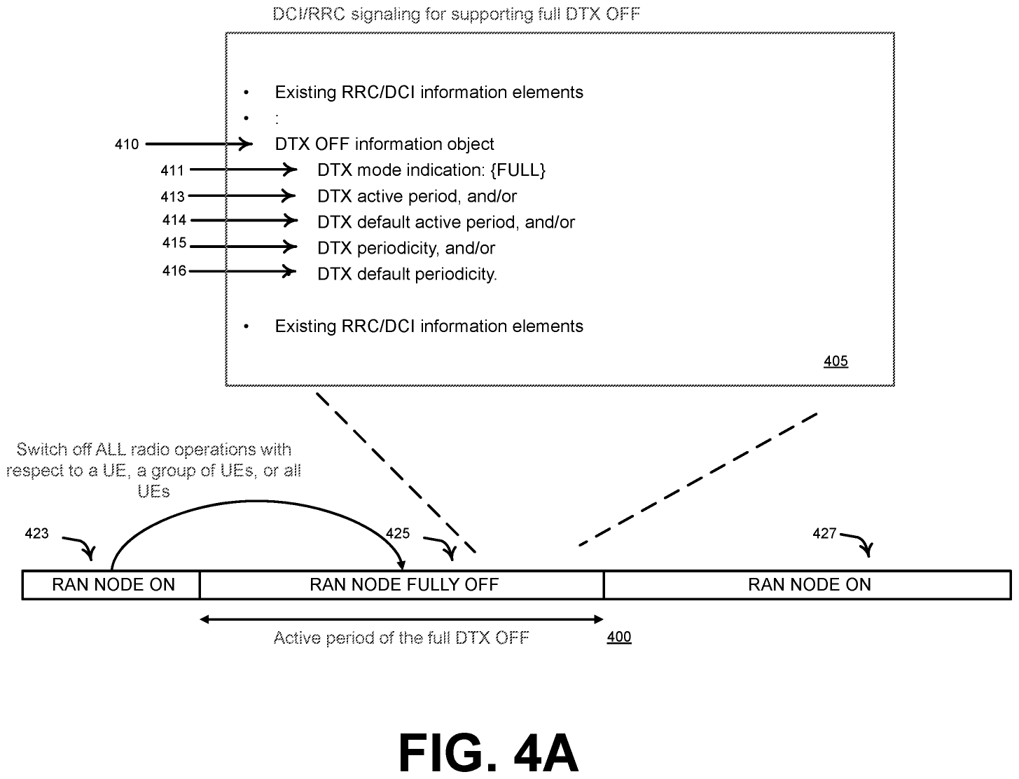

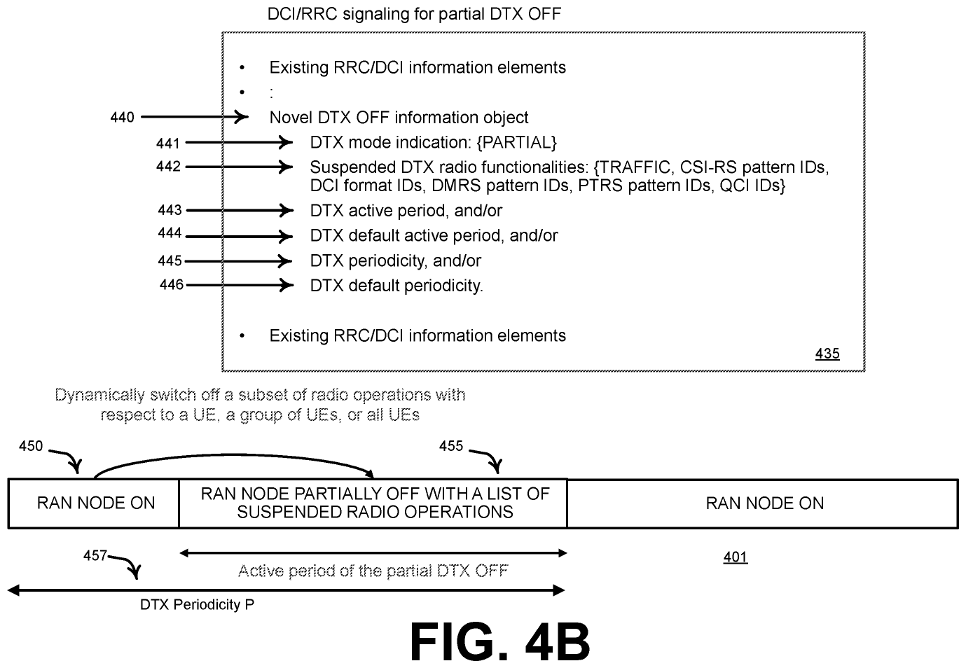

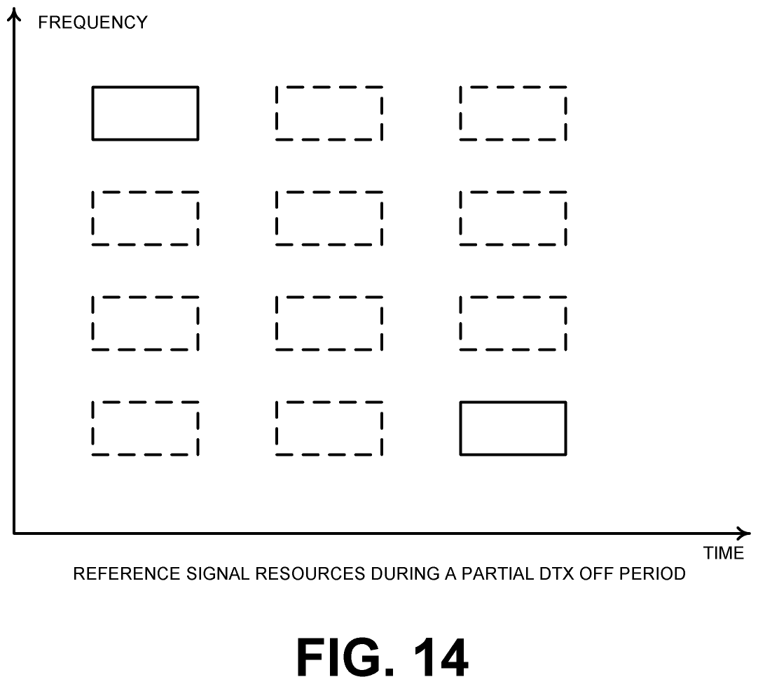

Embodiments disclosed herein facilitate a dynamic DTX adaptation, where unlike existing static DTX procedures, according to which all RAN node transmissions are shut down during DTX OFF periods, behavior of the RAN node during the configured DTX OFF periods is dynamically configurable with respect to active traffic flows or with respect to active user equipment devices. Thus, for example, during a partial DTX OFF period as disclosed herein, a RAN node may halt all transmissions with respect to a subset of user equipment device being served by the node, while for another subset of devices the node may only halt most transmissions but may still transmit less-energy-consuming control channel formats and reference signals. Continuing to transmit traffic and some reference signaling may facilitate traffic flows having stringent QoS requirements being transmitted but control signaling and assistance reference signaling being relaxed, (e.g., selecting limited size control signaling formats or adopting reference signals patterns of less reference signal density, a shown in, for example, FIG. 14), which may facilitate reasonable decoding ability at a user equipment while the RAN node achieves an energy saving gain. In embodiments, a RAN node may define a list of DTX function groups, where each DTX function group corresponds to configured transmission functionality of the RAN node during a partial DTX OFF period. A DTX group indication may define RAN node behavior/functionality in terms of available signals and radio functions for transmission during a partial DTX OFF period. Examples include maintaining traffic transmission, continuing reference signal transmission but with modified pattern or reference signal density, or continuing transmission of certain downlink control information formats during portion of a DTX cycle that is otherwise configured to be a DTX OFF period with no transmission functionality. On condition of a user equipment being configured with a certain DTX function group for a configured DTX OFF period, or for a configured number of DTX OFF periods, the user equipment may expect the RAN node to follow the transmission behavior as indicated by the indicated DTX function group only during indicated partial DTX OFF periods. After a partial DTX OFF period expires, (according to configuration information such as may be contained in indication 440 described in more detail in reference to FIG. 4B), the user equipment may operate as if the functions indicated as being active during a partial DTX OFF period are no longer active during future DTX OFF periods that may have been configured according to a conventional DTX transmission configuration. Thus, by implementing a partial DTX OFF period during a period that is configured to otherwise be a full DTX OFF period, a network node may trade off achievable energy saving gain that could be achieved by implementing full DTX OFF for user equipment devices that can tolerate performance degradation of the DTX procedures in exchange for achieving less energy saving gain (but still achieving some energy saving gain) while offering reasonable radio functionality to user equipment conducting communication sessions that comprise traffic flows that have stringent QoS requirements.

Unlike existing DTX procedures that use a static DTX design according to which a RAN node halts all transmissions for all user equipment devices during DTX OFF periods, using embodiments disclosed herein, during DTX OFF periods transmission behavior of RAN nodes is dynamically configurable. A RAN node may be dynamically configured to not only keep active some transmission functionality during a partial DTX OFF period, but to also facilitate different transmission functions being active with respect to different user equipment or with respect to different groups of user equipment. For example, during a partial DTX OFF period disclosed herein a RAN node conducting a best effort communication session with user equipment may halt all radio transmission towards the user equipment. During the same partial DTX OFF period, the RAN node may keep active data traffic transmission for a stringent QoS session corresponding to another user equipment but with relaxed control channel signaling or reference signal density towards device. FIG. 14 shows active reference signal resources in solid lines and reference signal resources that are deactivated during a partial DTX OFF period in dashed lines. Deactivating some, but not, all reference signal resources may result in energy saving at the radio access network node that is implementing a partial DTX OFF period while facilitating reference signaling that is adequate for user equipment that are conducting a communication session that comprises critical QoS requirements and that are in close range to the node, or that may not be moving with respect to the node, such that uplink or downlink signal strengths between the UE and the RAN support the communication session QoS requirement. Deactivating some, but not, all reference signal resources may result in energy saving at the radio access network node while still providing adequate support for user equipment that may have moderate signal strength levels with respect to the node but that are conducting communication session that do not comprise stringent QoS requirement, such as may be the case with a best effort communication session.

Instead of DTX conventionally-configured DTX cycles that are cell specific (e.g., common for all user equipment devices being served by a RAN node) and that only carry timing information corresponding to DTX ON and OFF periods, embodiments disclosed herein may comprise novel signaling information that is device-specific or that is device-group-specific and that may carry dynamic information indicative of available radio signals and functions that are being operated, or that are scheduled to be operated, by a radio access network node during one or more DTX OFF periods. A period during which operation of some transmission radio functionality is active may be referred to as a partial DTX OFF period or a partial transmission off mode period.

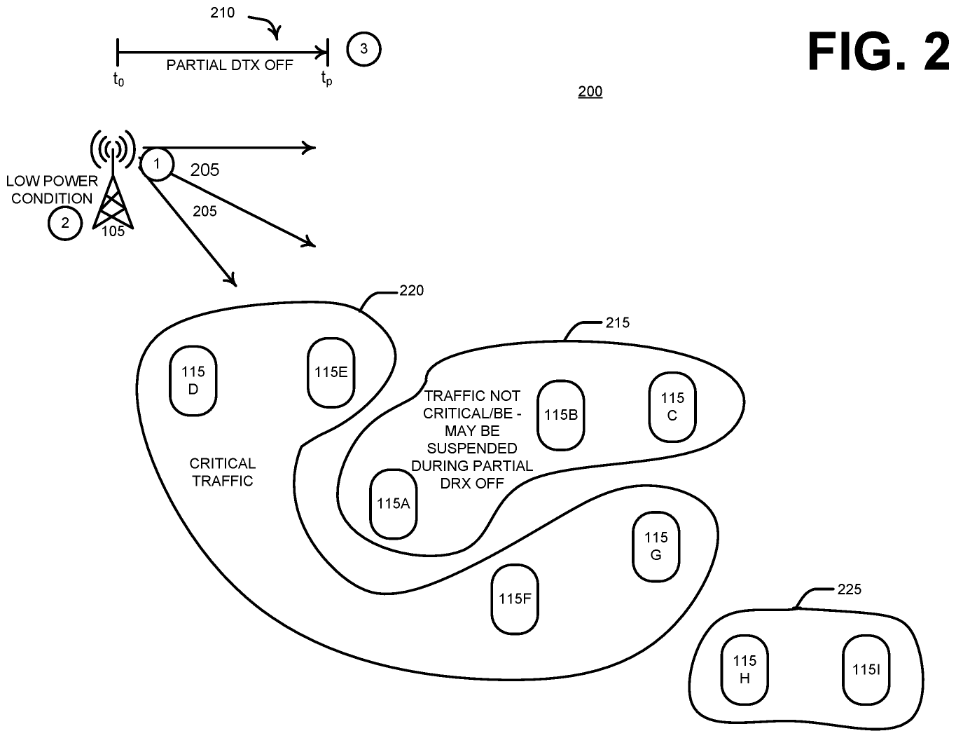

Turning now to FIG. 2, the figure illustrates an example environment 200 with multiple user equipment 115 in multiple user equipment groups 215, 220, and 225. Group 215 may comprise user equipment 115A, 115B, and 115C. User equipment of group 215 may be grouped together because they are not operating communication sessions that comprise critical traffic. Thus, for example, radio access network node 105 may configure user equipment of group 215 to expect that all transmission radio functions will be turned off, or halted, during partial DTX OFF period 210. Group 220 may comprise user equipment 115D, 115E, 115F, and 115G. User equipment of group 220 may be currently conducting communication sessions with radio access network node 105 that comprise critical traffic, for example traffic having a stringent latency requirement. Accordingly, radio access network node 105 may configure user equipment of group 220 to expect that downlink traffic transmission for the critical traffic flows to the user equipment of group 220 may continue during partial DTX off period 210. Although data traffic transmission may not be suspended during a partial DTX OFF period 210 with respect to user equipment of group 220, active reference signal signaling resources may be reduced, or ‘relaxed’, as shown in FIG. 14, with respect to user equipment of group 220. User equipment group 225 may comprise user equipment 115H and 1151. User equipment of group 225 may be located far enough away from radio access network node 105 such that if user equipment of group 225 conduct communication sessions comprising stringent latency requirements, relaxation of reference signal signaling may not be implemented due to the user equipment of group 225 needing optimized beam selection and other signal refining due to distance of the members of group 225 from radio access network node 105. User equipment of groups 215, 220 and 225 may be configured at act 1 by radio access network node 105 according to group-specific scrambling codes to expect different behavior from radio access network node 105 during partial DTX OFF period 210. At act 2, radio access network node 105 may detect, or determine, a low power condition, such as loss of offsite power causing the radio access network node to operate on battery power, or a low batter power condition after the RAN node has been operating on battery power. It will appreciated that radio access network node 105 may determine to implement a partial DTX OFF period at act 2 even if the node is receiving offsite power. At act 3, radio access network node 105 may implement partial DTX OFF period 210 such that different transmission radio functions are active with respect to one of the groups 215, 224, 225 than functions that are active with respect to another of the groups during the DTX OFF period.

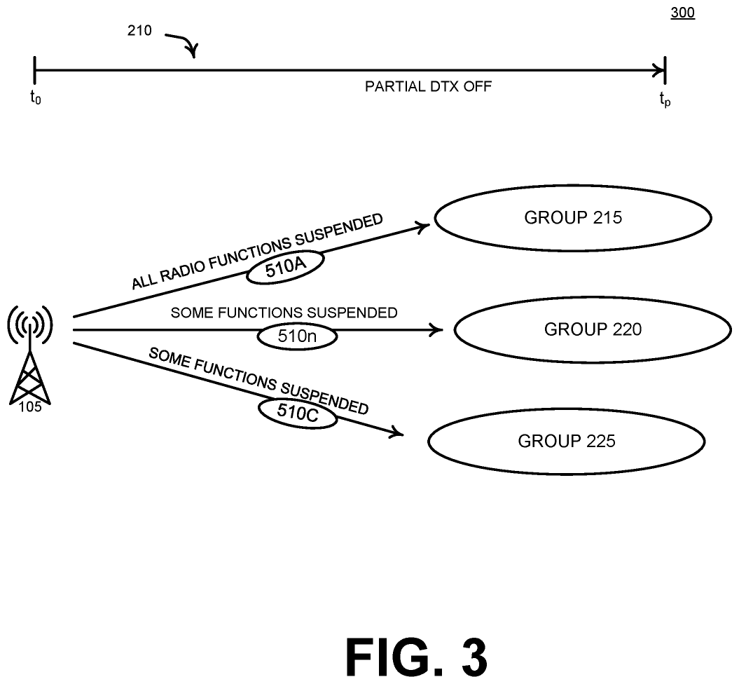

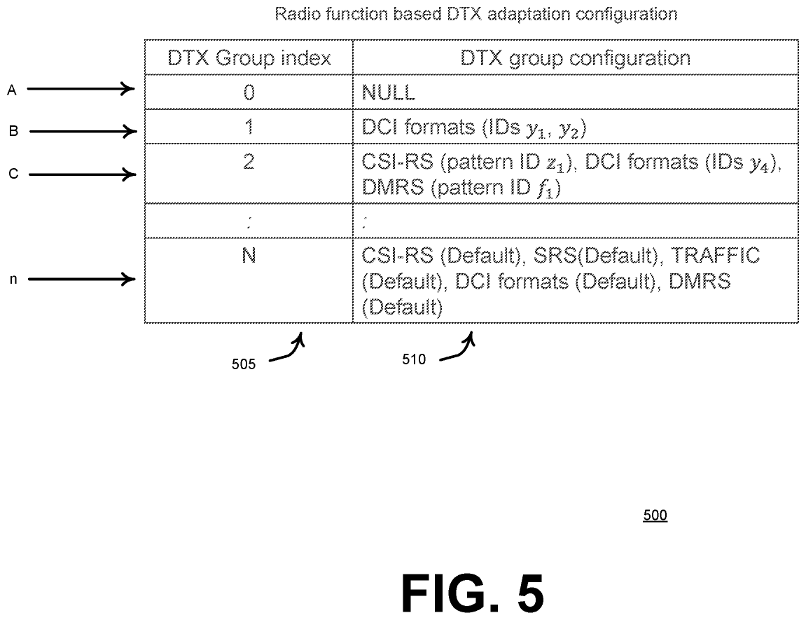

FIG. 3 illustrates an example environment 300 with a radio access network node 105 operating different radio functions with respect to different user equipment during configured partial discontinuous transmission OFF period 210. User equipment members of groups 215, 220, or 225 may receive different partial transmission mode configurations 440A, 440N, or 449C, respectively. Transmission mode configurations 440 are described in more detail in reference to FIG. 4B. Transmission mode configuration 440A, 440N, or 440C may comprise group function indices 505A, 505n, or 505C, respectively, described in more detail in reference to FIG. 5. As an example, RAN 105 may halt all transmission radio functions during partial DTX OFF period 210 with respect to user equipment of user equipment group 215 according to functions listed in function group 510A shown in FIG. 5 as being NULL (e.g., all transmission functions off), while functions listed in function group 510n shown in FIG. 5 may be implemented during partial the DTX OFF period with respect to user equipment of group 220 based on the critical nature of traffic corresponding to user equipment in group 220, and functions listed in function group 510C shown in FIG. 5 may be implemented during the partial DTX OFF period with respect to user equipment of group 225 based on the distance from RAN 105 to user equipment in group 225. It will be appreciated that radio access network node 105 may use different criterion to determine how to, or whether to, group user equipment devices into one or more groups, and to determine which transmission radio functions to operate with respect to different user equipment or different user equipment groups during a partial DTX OFF period.

As shown in FIG. 4A, during conventional discontinuous cycle 400, all transmission radio functions are shut down at a RAN node during discontinuous transmission period 425 (e.g., all functions are NULL during the discontinuous transmission period). During discontinuous transmission cycle 400, a RAN node switches from DTX ON period 423 to DTX OFF period 425 and back to DTX ON period 427. During DTX OFF period 425, all radio transmissions from a RAN node operating according to DTX cycle 400 are ‘assumed’, by a user equipment, to be halted until next DTX ON period 427.

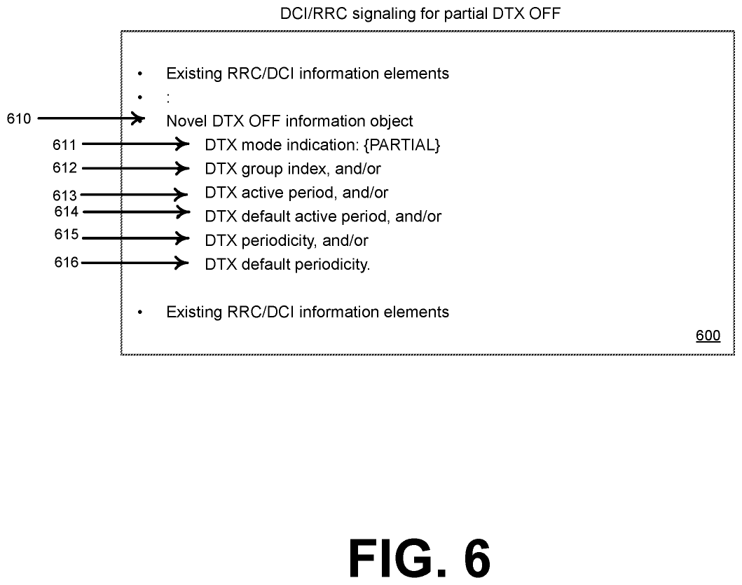

In contrast, using an embodiment shown in FIG. 4B, a radio access network node may implement dynamic DTX switching cycle 401 to dynamically implement a partial discontinuous transmission mode of operation according to a transmission mode configuration that may indicate suspension of various radio functionality during the partial discontinuous transmission mode of operation (e.g., during partial DTX OFF period 455) based on traffic to be delivered to user equipment. Whereas conventional DTX cycle 400 shown in FIG. 4A comprises full suspension of transmission radio functions during DTX OFF period 425, some radio functions may be active at the RAN node during partial DTX period 455 of partial transmission off mode cycle 401 shown in FIG. 4B. Operating during partial transmission mode off period 455 may comprise a radio access network node operating radio functions indicated by function indication element 442 in partial transmission off mode function indication 440. Indication 440 may comprise novel information added to a configuration message 435, such as, for example, a radio resource control signal (“RRC”) message or a downlink control information (“DCI”) message. Indication 440 may be referred to as a transmission mode configuration. In addition to function indication element 442, indication 440 may comprise DTX mode indication 441. Indication 440 may comprise one or more off mode period indications, such as DTX active period indication 443, DTX default active period indication 444, DTX periodicity indication 445, or DTX default periodicity indication 446. DTX mode indication 441 may indicate transmission mode that a radio access network node that transmits message 435 may operate. A ‘Partial’ indication in indication 441 may indicate that one or more radio transmission functions, (e.g., that may be indicated by indication 442) are to be operated by the radio access network node during partial DTX OFF period 455. DTX active period indication 443 may indicate a duration of partial DTX OFF period 455. DTX default active period indication 444 may indicate a DTX default active period if a configurable DTX active period has not been configured by an overall configuration that configures user equipment that are served by a RAN with a default or baseline DTX OFF period. DTX periodicity indication 445 may indicate a periodicity 457 that may be a total of a duration corresponding to ON period 450 and partial DTX OFF period 455. DTX default periodicity indication 446 may indicate a DTX default periodicity if a configurable DTX periodicity has not been configured by an overall configuration that configures user equipment that are served by a RAN with a default or baseline DTX periodicity. Indication 442 may indicate radio signaling radio function functionality that may be active during a partial DTX OFF period. Indication 442 may indicate radio signaling radio function functionality that may be suspended during a partial DTX OFF period. For example, indication 442 may indicate a combination of, during a partial DRX OFF period 455, one or more of: suspension of traffic, suspension of reference signaling, suspension of control channel pattern, or suspension of QoS profile accommodation. Indication 442 may comprise an index 505 described in reference to FIG. 5 (in which case message 435 may be referred to as message 600, and indication 442 may be referred to as indication 612 as described in reference to FIG. 6).

In FIG. 4A, a transmission off mode function indication 410 is shown that may indicate, or configure, a user equipment with a full off, full freezing, or full suspension of all transmission functionality at a RAN. Indication 410 may be used by a radio access network node to configure user equipment served by the node with a conventional, full off, DRX OFF period 425, during which all transmission functionality is suspended. Indication 410 may be part of an RRC or DCI configuration message 405 and may comprise DTX transmission mode indication 411, DTX active period indication 413, DTX default active period indication 414, DTX periodicity indication 415, or DTX default periodicity indication 416. Accordingly, conventional DTX cycle 400 comprising a full DTX OFF period 425, during which all transmission functionality may be inactive at a RAN node, may be indicated by message 405. A message 435 shown in FIG. 4B may comprise information indicative of novel DTX cycle 401, which may comprise partial DTX OFF period 455, during which some transmission functionality may be active at a RAN.

In an embodiment shown in FIG. 5, a RAN node may define one or more lists of DTX function groups, as shown in group configuration 500. Configuration 500 may be referred to as a transmission mode configuration. Configuration 500 may comprise one or more group indices, or indications, 505, which may respectively correspond to one or more DTX function group sets 510. A group index may be referred to as a partial transmission mode index. A DTX function group 510 may define one or more signals and/or functions to be activated during a partial DTX OFF period, which may coincide with an otherwise static DTX OFF period (e.g., a period that would be a conventional/static DTX OFF period but for being configured to be a partial DTX OFF period by a configuration 500 and/or indication 440 described in reference to FIG. 4B). Continuing with description of FIG. 5, a user equipment may be configured with function group/function set definitions 510. Instead of an indication 442 described in reference to FIG. 4B comprising a listing of functions that are to be active, or that are to be suspended, during a DTX OFF period, indication 442 may comprise a group identifier/index 505. Thus, a device, or a group of user equipment devices, may receive from a RAN a configuration message comprising a function group indication 505. Unlike existing conventional DTX configurations that are RAN/cell specific, a message comprising an indication 505, or an indication 440/442 shown in FIG. 4B, can be directed to one user equipment, or to a group of user equipment, according to a device-specific scrambling code or according to a group-specific scrambling code, respectively.

As an example, a DTX group 1 indication 505B shown in FIG. 5 may be indicative to one or more user equipment that receive the indication that a RAN node will be supporting DCI formats having DCI format identifiers specified in block 510B of configuration 500. Functions listed in a group function listing 510 as being altered during a partial DTX OFF period may comprise support for channel state information reference signals (CSI-RS) not being supported and thus CSI-RS transmission being suspended during a partial DTX OFF period. Functions that may be altered during a partial DTX OFF period may comprise sounding reference signaling (“SRS” procedures being active for a given SRS while other SRS patterns (with other SRS signal densities) being suspended. Functions that may be altered during a partial DTX OFF period may comprise downlink traffic transmission and delivery in the downlink being suspended, which may facilitate user equipment that may be conducting critical QoS traffic flows that comprise mainly transmitting in the uplink direction but with infrequent uplink traffic to transmit still having their respective uplink channels being tracked, and accurately estimated for enhanced radio reliability. Thus, support for SRS transmission from a UE and uplink channel reporting (e.g., reports transmitted from a RAN to a UE) may remain active during a DTX OFF period).

As shown in FIG. 6, as part of DTX configurations 600 message, user equipment can be dynamically configured with a function group indication, or index, 612, which may comprise an index value 505 corresponding to an active DTX function group 510 shown in FIG. 5. Index indication 612 may be indicative of functions to be adopted by s RAN node during a configured partial DTX OFF period, which may be configured via indication 610. Indication 610 is similar to indication 440 shown in FIG. 4B but indication 610 comprises group index indication 612, which may be indicative of an index 505, instead of comprising a listing of function 442. DTX configuration message 600 can be device-specific (e.g., transmitted in a message according to a device-specific scrambling code) or device-group-specific (e.g., transmitted in a message according to a device-group-specific scrambling code) instead of being globally applied to all user equipment being served by a RAN node. Thus, based on different DTX function group indications 610 being received by different user equipment devices, the different user equipment may ‘expect’ different behavior of the serving RAN node during on or more active DTX OFF periods. A group of functions may be activated, or may remain active, during a partial DTX OFF period according to a mode indication 611 indicating partial activation of functions indicated by group function indicator index 505 (shown in FIG. 5), and according to partial DRX OFF period indication 613, default DRX active period (e.g., a DTX ON period) indication 614, a DTX OFF periodicity indication 615, and a default DTX periodicity 616. Accordingly, by implementing a partial DTX OFF period, a RAN node may dynamically trade off some network energy saving gain, while still achieving energy saving gain, in exchange for maintaining radio performance for some user equipment, based on traffic corresponding to some user equipment but not to other user equipment or based on other conditions corresponding to some user equipment but not to other user equipment.

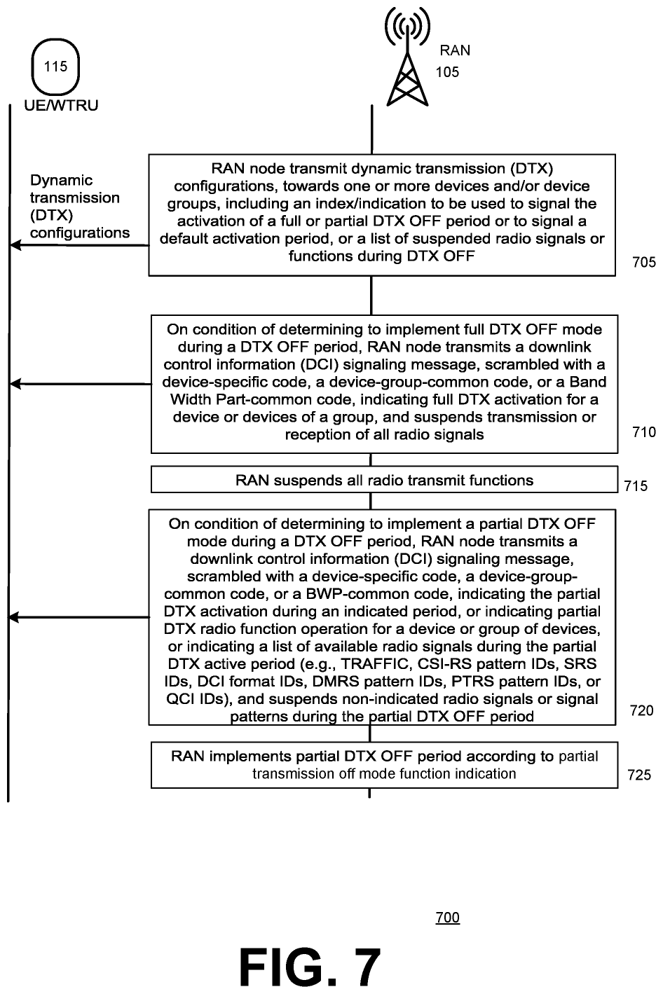

Turning now to FIG. 7, the figure illustrates a timing diagram of an example embodiment method 700 to partially operate, by radio access network node 105, one or more radio functions during a configured DTX OFF period, which period of time may be configured as a default transmission mode period during which all transmission radio functions are suspended, halted, frozen, or otherwise inactive. A transmission function being in an inactive state may be referred to as being in a NULL state. Transmission radio functions being in a NULL state is a transmission mode that may be configured globally for all user equipment serviced by a RAN, for example all UE devices 115 shown in FIG. 2, as part of a conventional static DTX configuration, which may be a default configuration. Continuing with description of FIG. 7, at act 705, RAN node 105 may transmit dynamic discontinuous transmission configurations, which may be referred to as a transmission mode configurations, towards one or more user equipment or towards one or more user equipment groups. One or more transmission mode configurations may be transmitted to a specific user equipment according to a device-specific scrambling code or to one or more user equipment of a group of user equipment according to a group-specific scrambling code. A transmission mode configuration may comprise an indication indicative of activation of a full or partial DTX OFF period, an activation period during which the full or partial DTX OFF period is scheduled to be in effect, or a list of radio signals functions that are scheduled to be active during a partial DTX OFF period corresponding to listed functions. A transmission mode configuration may comprise an index corresponding to a list of functions. A transmission mode configuration may comprise a mapping of one or more indexes, such as indexes 505 shown in FIG. 5, to one or more listings of functions 510.

On condition of scheduling of a full DTX OFF period with respect to UE 115, RAN node 105 may transmit at act 710 a downlink control information (DCI) signaling message to UE 115, scrambled with a device-specific code, a device-group-common code, or a band width parts-common code. The DCI message may indicate full DTX OFF activation (e.g., all radio transmission functions are off) for user equipment 115, or for user equipment of a group of user equipment that may comprise UE 115. At act 715, RAN 105 may implement full (e.g., NULL) suspension of all transmit radio functions during a period indicated in the message transmitted at act 710.

On condition of determining to implement a partial DTX mode (e.g., a partial DTX OFF period during which some radio functions are scheduled to be active), RAN node 105 may transmit to UE 115 at act 720 a partial transmission off mode function indication, such as, for example, message information 440 shown in FIG. 4B, or, for example, an indication 442 that may be part of indication 440. The partial transmission off mode function indication may comprise a function group index, such as an index 505 shown in FIG. 5, which index may be indicted by an index indication 612 that may be part of message 600 described in reference to FIG. 6. Continuing with description of FIG. 7, the partial transmission off mode function indication transmitted at act 720 may be transmitted to UE 115 as a downlink control information signaling message, scrambled with a device-specific code, a device-group-common code, or a band-width-parts-common code, indicative of one or more radio functions that are scheduled to be operative/active with respect to UE 115, or with respect to a group of user equipment that comprises UE 115, during a partial DTX OFF period indicated in the indication transmitted at act 720. The partial transmission off mode function indication transmitted at act 720 may comprise a function group indication, or the partial transmission off mode function indication may comprise a list of available radio signals or functions that are schedule to be active with respect to the user equipment or group of user equipment during a partial DTX OFF period indicated in the partial transmission off mode function indication. Performance of functions that may be active during a partial DTX OFF period may comprise: transmission of TRAFFIC, transmitting CSI-RS pattern identifiers, transmitting STS information, such as reports, transmitting DCI format identifiers, transmitting DMRS patterns identifiers, transmitting PTRS pattern identifiers, or transmitting QCI identifiers. At act 725, RAN node 105 may suspend, halt, or otherwise deactivate radio functions, which are not indicated by the partial transmission off mode function indication transmitted at act 720, during the partial DTX OFF period that may be indicated by the partial transmission off mode function indication transmitted at act 720.

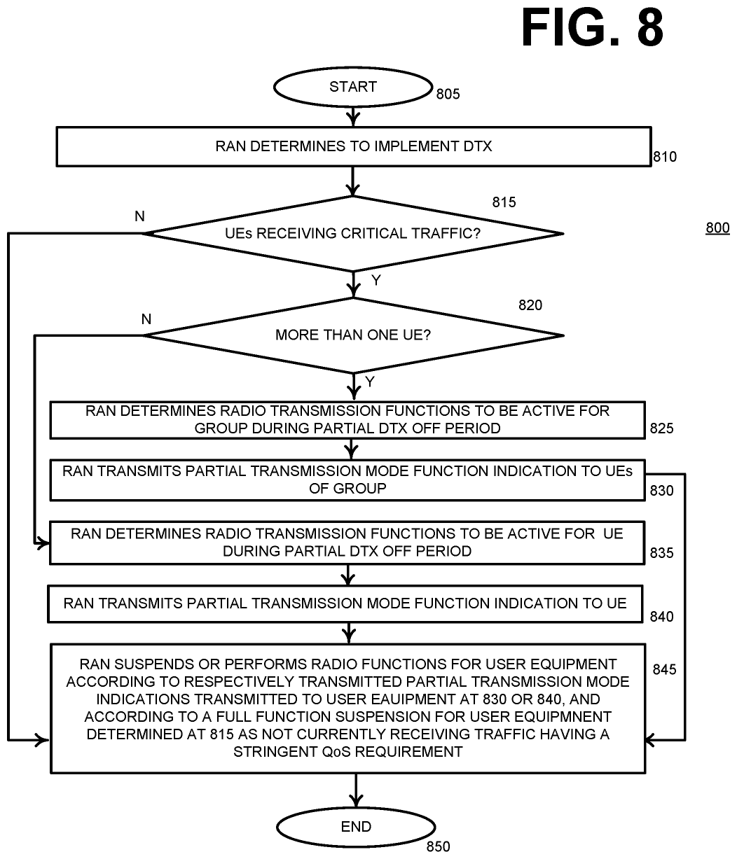

Turning now to FIG. 8, the figure illustrates a flow diagram of an example embodiment 800. Method 800 begins at act 805. At act 810, a radio access network node may determine to implement a discontinuous transmission OFF period. The radio access network node may determine to implement a discontinuous transmission OFF period to a power condition, for example, loss of offsite power, or if already operating on battery power due to loss of offsite power, based on a battery power level being lower than a configured criterion such as a charged threshold. At act 815, the radio access network node may determine whether one or more user equipment devices that may be served by the radio access network node are currently receiving, or are scheduled to receive, critical traffic (e.g., traffic having a stringent latency requirement). If a determination made it act 815 is that user equipment being served by the radio access network node is/are not scheduled to receive critical traffic, method 800 advances to act 845. At act 845, the radio access network node may suspend all transmission radio functions with respect to the user equipment.

Returning to description of act 815, if the radio access network node determines that at least one user equipment is currently receiving, or scheduled to receive, critical traffic, method 800 advances to act 820. At act 820, the radio access network node may determine whether more than one user equipment is scheduled to receive critical traffic. If a determination made at act 820 is that only one user equipment is scheduled to receive critical traffic, method 800 advances to act 835. At act 835, the radio access network node may determine one or more radio transmission functions that are to be active with respect to the user equipment that is receiving, or scheduled to receive, critical traffic, during a partial discontinuous transmission OFF period. At act 840, radio access network node may transmit a partial transmission mode function indication to the user equipment that is scheduled to receve, or is receiving, critical traffic. The partial transmission mode function indication may comprise a listing of radio transmission functions, or an index indicative thereof, that are to remain active, or to be activated, during a partial discontinuous transmission off. The partial transmission mode function indication may comprise an activation duration indication indicative of a length of time during which the indicated radio transmission function or functions are to be active during the partial discontinuous transmission OFF period indicated in the partial transmission mode function indication. At act 845, the radio access network node may suspend all radio transmission functions except the one or more radio transmission functions indicated in the indication transmitted at act 840 as being active during the partial discontinuous OFF period indicated at act 840.

Returning to description of act 820, if a determination is made that more than one user equipment is receiving, or scheduled to receive, critical traffic, method 800 advances to act 825. At act 825, the radio access network node may determine one or more radio transmission functions that are to remain active, or that are to be activated, with respect to user equipment of a group of user equipment that are scheduled to receive, or are receiving, critical traffic. If more than one user equipment are receiving, or are scheduled to receive, critical traffic the radio access network node may determine one or more groupings of the user equipment according to traffic flows corresponding to the different user equipment such that user equipment scheduled to receive, or that are receiving, critical traffic having similar quality of service requirements may be grouped into the same group. At act 830, the radio access network node may transmit a partial mode function indication to user equipment devices of the one or more groups of user equipment according to scrambling codes, for example, scrambling codes that are respectively specific to the one or more groups. Accordingly, one group of user equipment comprising user equipment having similar critical traffic characteristics may receive a different partial transmission mode function indication than user equipment of another group of user equipment corresponding to critical traffic (or noncritical traffic) having different quality of service requirements. At act 845, the radio access network node may suspend one or more radio transmission functions corresponding to partial transmission mode function indications transmitted to the group, or groups, of user equipment according to the partial transmission mode function indication transmitted specifically (e.g., according to group-specific codes) to the user equipment of the particular group, or groups, of user equipment. (It will be appreciated that when the radio access network node transmits to the one user equipment at act 840 a partial transmission mode function indication, the partial transmission mode function indication may be transmitted according to a scrambling code that is unique to the user equipment.)

Accordingly, a radio access network node, during a partial discontinuous transmission OFF period, may operate a certain first group of radio transmission functions with respect to a first group of one or more user equipment, and may operate a different, or second, group of the one or more radio transmission functions with respect to a second group, or set, of one or more user equipment during a partial DTX OFF period, which period may otherwise have been configured as a default period during which operation of all radio transmission functions during a default discontinuous OFF period would have been suspended. It will be appreciated that at act 845, operation of one or more radio functions with respect to one user equipment, or with respect to a group of user equipment, may comprise a suspension of all radio functions during a particular discontinuous transmission OFF period, but operation with respect to another user equipment, or with respect to another group of user equipment, may comprise a partial suspension of radio transmission functions but also a partial active operation of certain radio transmission functions based on characteristics corresponding to the other user equipment or to the other group of user equipment. Characteristics used as a basis for differentiating operating of radio transmission functionality during a partial DTX OFF period between one group of user equipment and another may comprise, for example, traffic quality of service requirements, signal strength quality at the user equipment, or other characteristics that may benefit from operation of some radio transmission functions even if not all radio transmission functions that the radio access network node is capable of operating are activate during an indicated partial discontinuous transmission OFF period.

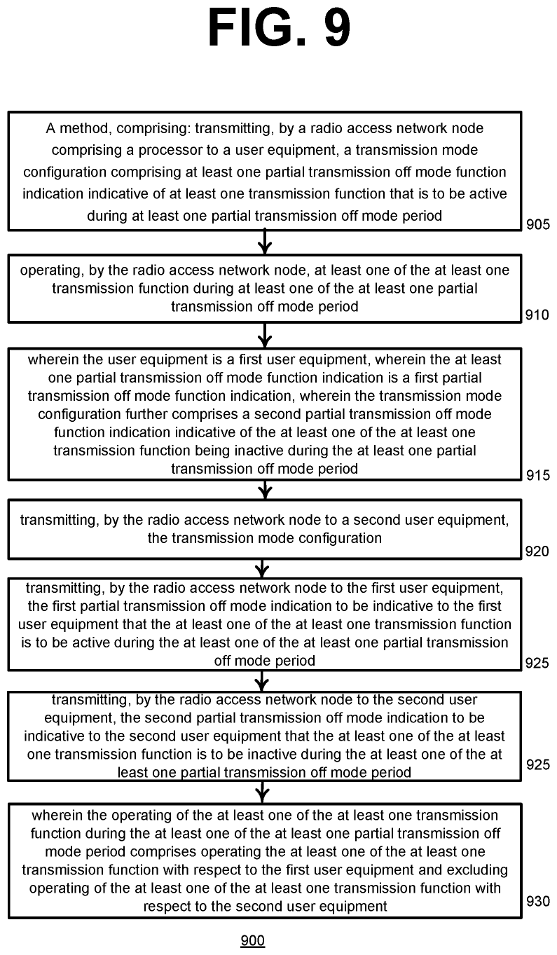

Turning now to FIG. 9, the figure illustrates an example embodiment method 900 comprising at block 905 transmitting, by a radio access network node comprising a processor to a user equipment, a transmission mode configuration comprising at least one partial transmission off mode function indication indicative of at least one transmission function that is to be active during at least one partial transmission off mode period; at block 910 operating, by the radio access network node, at least one of the at least one transmission function during at least one of the at least one partial transmission off mode period; at block 915 wherein the user equipment is a first user equipment, wherein the at least one partial transmission off mode function indication is a first partial transmission off mode function indication, wherein the transmission mode configuration further comprises a second partial transmission off mode function indication indicative of the at least one of the at least one transmission function being inactive during the at least one partial transmission off mode period; at block 920 transmitting, by the radio access network node to a second user equipment, the transmission mode configuration; at block transmitting, by the radio access network node to the first user equipment, the first partial transmission off mode indication to be indicative to the first user equipment that the at least one of the at least one transmission function is to be active during the at least one of the at least one partial transmission off mode period; at block 925 transmitting, by the radio access network node to the second user equipment, the second partial transmission off mode indication to be indicative to the second user equipment that the at least one of the at least one transmission function is to be inactive during the at least one of the at least one partial transmission off mode period; and at block 930 wherein the operating of the at least one of the at least one transmission function during the at least one of the at least one partial transmission off mode period comprises operating the at least one of the at least one transmission function with respect to the first user equipment and excluding operating of the at least one of the at least one transmission function with respect to the second user equipment.

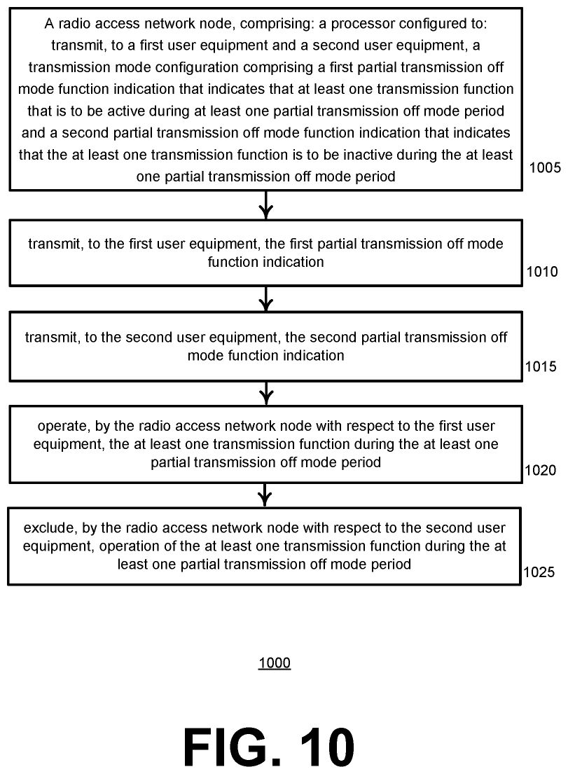

Turning now to FIG. 10, the figure illustrates an example radio access network node, comprising at block 1005 a processor configured to transmit, to a first user equipment and a second user equipment, a transmission mode configuration comprising a first partial transmission off mode function indication that indicates that at least one transmission function that is to be active during at least one partial transmission off mode period and a second partial transmission off mode function indication that indicates that the at least one transmission function is to be inactive during the at least one partial transmission off mode period; at block 1010 transmit, to the first user equipment, the first partial transmission off mode function indication; at block 1015 transmit, to the second user equipment, the second partial transmission off mode function indication; at block 1020 operate, by the radio access network node with respect to the first user equipment, the at least one transmission function during the at least one partial transmission off mode period; and at block 1025 exclude, by the radio access network node with respect to the second user equipment, operation of the at least one transmission function during the at least one partial transmission off mode period.

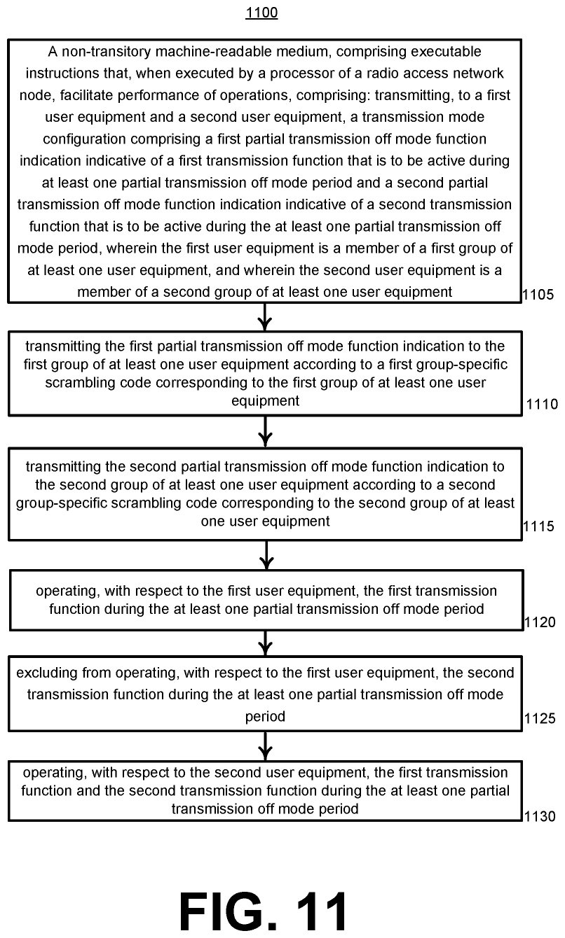

Turning now to FIG. 11, the figure illustrates a non-transitory machine-readable medium 1100 comprising at block 1105 executable instructions that, when executed by a processor of a radio access network node, facilitate performance of operations, comprising transmitting, to a first user equipment and a second user equipment, a transmission mode configuration comprising a first partial transmission off mode function indication indicative of a first transmission function that is to be active during at least one partial transmission off mode period and a second partial transmission off mode function indication indicative of a second transmission function that is to be active during the at least one partial transmission off mode period, wherein the first user equipment is a member of a first group of at least one user equipment, and wherein the second user equipment is a member of a second group of at least one user equipment; at block 1110 transmitting the first partial transmission off mode function indication to the first group of at least one user equipment according to a first group-specific scrambling code corresponding to the first group of at least one user equipment; at block 1115 transmitting the second partial transmission off mode function indication to the second group of at least one user equipment according to a second group-specific scrambling code corresponding to the second group of at least one user equipment; at block 1120 operating, with respect to the first user equipment, the first transmission function during the at least one partial transmission off mode period; at block 1125 excluding from operating, with respect to the first user equipment, the second transmission function during the at least one partial transmission off mode period; and at block 1130 operating, with respect to the second user equipment, the first transmission function and the second transmission function during the at least one partial transmission off mode period.

In order to provide additional context for various embodiments described herein, FIG. 12 and the following discussion are intended to provide a brief, general description of a suitable computing environment 1200 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors and may include a cache memory. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

Computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1210. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can comprise a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

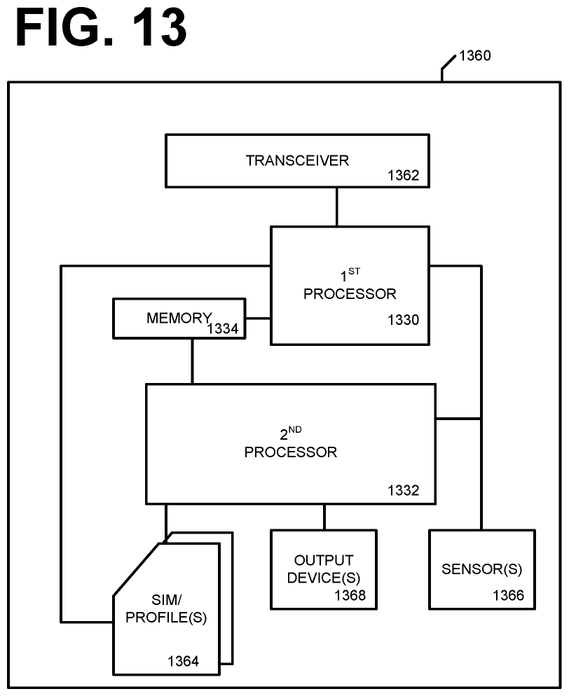

Turning now to FIG. 13, the figure illustrates a block diagram of an example UE 1360. UE 1360 may comprise a smart phone, a wireless tablet, a laptop computer with wireless capability, a wearable device, a machine device that may facilitate vehicle telematics, and the like. UE 1360 comprises a first processor 1330, a second processor 1332, and a shared memory 1334. UE 1360 includes radio front end circuitry 1362, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1362 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 13, UE 1360 may also include a SIM 1364, or a SIM profile, which may comprise information stored in a memory (memory 34 or a separate memory portion), for facilitating wireless communication with RAN 105 or core network 130 shown in FIG. 1. FIG. 13 shows SIM 1364 as a single component in the shape of a conventional SIM card, but it will be appreciated that SIM 1364 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1364 and another device, which may be a component of RAN 105 or core network 130 shown in FIG. 1). A SIM profile 1364 may also comprise identifying information that is unique to the SIM, or SIM profile, such as, for example, an International Mobile Subscriber Identity (“IMSI”) or information that may make up an IMSI.

SIM 1364 is shown coupled to both the first processor portion 1330 and the second processor portion 1332. Such an implementation may provide an advantage that first processor portion 30 may not need to request or receive information or data from SIM 1364 that second processor 1332 may request, thus eliminating the use of the first processor acting as a ‘go-between’ when the second processor uses information from the SIM in performing its functions and in executing applications. First processor 1330, which may be a modem processor or baseband processor, is shown smaller than processor 1332, which may be a more sophisticated application processor, to visually indicate the relative levels of sophistication (i.e., processing capability and performance) and corresponding relative levels of operating power consumption levels between the two processor portions. Keeping the second processor portion 1332 asleep/inactive/in a low power state when UE 1360 does not need it for executing applications and processing data related to an application provides an advantage of reducing power consumption when the UE only needs to use the first processor portion 1330 while in listening mode for monitoring routine configured bearer management and mobility management/maintenance procedures, or for monitoring search spaces that the UE has been configured to monitor while the second processor portion remains inactive/asleep.

UE 1360 may also include sensors 1366, such as, for example, temperature sensors, accelerometers, gyroscopes, barometers, moisture sensors, and the like that may provide signals to the first processor 1330 or second processor 1332. Output devices 1368 may comprise, for example, one or more visual displays (e.g., computer monitors, VR appliances, and the like), acoustic transducers, such as speakers or microphones, vibration components, and the like. Output devices 1368 may comprise software that interfaces with output devices, for example, visual displays, speakers, microphones, touch sensation devices, smell or taste devices, and the like, that are external to UE 1360.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| DTX | Discontinuous transmission |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
transmitting, by a radio access network node comprising a processor to a user equipment, a transmission mode configuration comprising at least one partial transmission off mode function indication indicative of at least one transmission function that is to be active during at least one partial transmission off mode period; and
operating, by the radio access network node, at least one of the at least one transmission function during at least one of the at least one partial transmission off mode period.

2. The method of claim 1, wherein the at least one transmission function comprises at least one of: a sounding reference signal function, a reference signal function, a downlink control information format function, a demodulation reference signal function, or a traffic function.

3. The method of claim 1, wherein the at least one of the at least one partial transmission off mode period coincides with a configured discontinuous transmission off period.

4. The method of claim 1, wherein the at least one of the at least one partial transmission off mode period is at least partially noncoincidental with a configured discontinuous transmission off period.

5. The method of claim 1, further comprising:
analyzing, by the radio access network node, a power supply parameter value with respect to a power supply parameter criterion to result in an analyzed power supply parameter value,
wherein determining to operate the at least one of the at least one transmission function during the at least one of the at least one partial transmission off mode period is based on the analyzed power supply parameter value being determined to satisfy the power supply parameter criterion.

6. The method of claim 1, wherein the transmission mode configuration comprises an off mode period indication indicative of a period parameter corresponding to the at least one partial transmission off mode period.

7. The method of claim 1, wherein the at least one partial transmission off mode function indication is a first partial transmission off mode function indication, wherein the at least one transmission function that is to be active during the at least one partial transmission off mode period is a first transmission function, wherein the at least one partial transmission off mode period is a first partial transmission off mode period, and wherein the transmission mode configuration comprises a second partial transmission off mode function indication indicative of a second transmission function that is to be active during a second off mode period.

8. The method of claim 7, wherein the transmission mode configuration comprises a first off mode period indication indicative of a first period parameter value corresponding to the first partial transmission off mode period, and wherein the transmission mode configuration comprises a second off mode period indication indicative of a second period parameter value corresponding to the second partial transmission off mode period.

9. The method of claim 8, wherein the first period parameter value is a first duration corresponding to the first partial transmission off mode period, and wherein the second period parameter value is a second duration corresponding to the second partial transmission off mode period.

10. The method of claim 1, wherein the at least one partial transmission off mode function indication comprises a partial transmission off mode index corresponding to the at least one of the at least one partial transmission off mode period, and the method further comprising:
transmitting, by the radio access network node to the user equipment, the partial transmission off mode index to be indicative, to the user equipment, of the operating of the at least one of the at least one transmission function during the at least one of the at least one partial transmission off mode period.

11. The method of claim 1, wherein the user equipment is a first user equipment, wherein the at least one partial transmission off mode function indication is a first partial transmission off mode function indication, wherein the transmission mode configuration further comprises a second partial transmission off mode function indication indicative of the at least one of the at least one transmission function being inactive during the at least one partial transmission off mode period, and the method further comprising:
transmitting, by the radio access network node to a second user equipment, the transmission mode configuration;
transmitting, by the radio access network node to the first user equipment, the first partial transmission off mode indication to be indicative to the first user equipment that the at least one of the at least one transmission function is to be active during the at least one of the at least one partial transmission off mode period; and
transmitting, by the radio access network node to the second user equipment, the second partial transmission off mode indication to be indicative to the second user equipment that the at least one of the at least one transmission function is to be inactive during the at least one of the at least one partial transmission off mode period.

12. The method of claim 11, wherein the operating of the at least one of the at least one transmission function during the at least one of the at least one partial transmission off mode period comprises operating the at least one of the at least one transmission function with respect to the first user equipment and excluding operating of the at least one of the at least one transmission function with respect to the second user equipment.

13. The method of claim 11, wherein the first partial transmission off mode function indication comprises a first partial transmission mode index, and wherein the second partial transmission off mode function indication comprises a second partial transmission mode index.

14. A radio access network node, comprising:
a processor configured to:
transmit, to a first user equipment and a second user equipment, a transmission mode configuration comprising a first partial transmission off mode function indication that indicates that at least one transmission function that is to be active during at least one partial transmission off mode period and a second partial transmission off mode function indication that indicates that the at least one transmission function is to be inactive during the at least one partial transmission off mode period;
transmit, to the first user equipment, the first partial transmission off mode function indication;
transmit, to the second user equipment, the second partial transmission off mode function indication;
operate, by the radio access network node with respect to the first user equipment, the at least one transmission function during the at least one partial transmission off mode period; and
exclude, by the radio access network node with respect to the second user equipment, operation of the at least one transmission function during the at least one partial transmission off mode period.

15. The radio access network node of claim 14, wherein the radio access network node transmits the first partial transmission off mode function indication to the first user equipment according to a first device-specific scrambling code uniquely corresponding to the first user equipment, and wherein the radio access network node transmits the second partial transmission off mode function indication to the second user equipment according to a second device-specific scrambling code uniquely corresponding to the second user equipment.

16. The radio access network node of claim 14, wherein the first user equipment is a member of a first group of at least one user equipment, and wherein the second user equipment is a member of a second group of at least one user equipment.

17. The radio access network node of claim 16, wherein the radio access network node transmits the first partial transmission off mode function indication to the first group of at least one user equipment according to a first group-specific scrambling code uniquely corresponding to the first group of at least one user equipment, and wherein the radio access network node transmits the second partial transmission off mode function indication to the second group of at least one user equipment according to a second group-specific scrambling code uniquely corresponding to the second group of at least one user equipment.

18. A non-transitory machine-readable medium, comprising executable instructions that, when executed by a processor of a radio access network node, facilitate performance of operations, comprising:
transmitting, to a first user equipment and a second user equipment, a transmission mode configuration comprising a first partial transmission off mode function indication indicative of a first transmission function that is to be active during at least one partial transmission off mode period and a second partial transmission off mode function indication indicative of a second transmission function that is to be active during the at least one partial transmission off mode period, wherein the first user equipment is a member of a first group of at least one user equipment, and wherein the second user equipment is a member of a second group of at least one user equipment;
transmitting the first partial transmission off mode function indication to the first group of at least one user equipment according to a first group-specific scrambling code corresponding to the first group of at least one user equipment;
transmitting the second partial transmission off mode function indication to the second group of at least one user equipment according to a second group-specific scrambling code corresponding to the second group of at least one user equipment; and
operating, with respect to the first user equipment, the first transmission function during the at least one partial transmission off mode period;
excluding from operating, with respect to the first user equipment, the second transmission function during the at least one partial transmission off mode period; and
operating, with respect to the second user equipment, the first transmission function and the second transmission function during the at least one partial transmission off mode period.

19. The non-transitory machine-readable medium of claim 18, the operations further comprising:
analyzing a first signal strength corresponding to at least one of the first group of at least one user equipment with respect to a first signal strength criterion to result in an analyzed first signal strength; and
based on the analyzed first signal strength being determined to satisfy the first signal strength criterion, determining to transmit the first partial transmission off mode function indication to the first group of at least one user equipment.

20. The non-transitory machine-readable medium of claim 18, the operations further comprising:
analyzing a second signal strength corresponding to at least one of the second group of at least one user equipment with respect to a second signal strength criterion to result in an analyzed second signal strength; and
based on the analyzed second signal strength being determined to satisfy the second signal strength criterion, determining to transmit the second partial transmission off mode function indication to the second group of at least one user equipment,
wherein satisfaction of the first signal strength criterion corresponds to a determination of a first signal strength value that is higher than a second signal strength value that satisfies the second signal strength criterion.
